(19) United States
(12) Patent Application Publication
(10) Pub. No.: US 2026/0305811 A1
(43) Pub. Date: Oct. 8, 2026

(54) SPIGOT MOUNTED PAINTBRUSH CLEANER

(71) Applicant: Jason Christopher Quan, Phoenix, AZ (US)

(72) Inventor: Jason Christopher Quan, Phoenix, AZ (US)

(21) Appl. No.: 19/169,248

(22) Filed: Apr. 3, 2025

(51) Int. Cl. A46B 17/06; A46B 13/00; B44D 3/00

(52) U.S. Cl. CPC A46B 17/06; A46B 13/001; B44D 3/006; A46B 2200/30

(57) ABSTRACT

A paintbrush cleaner features a circular brush which rotates on a shaft within a cylindrical housing. The cylindrical housing has a bored threaded interface for attaching to a residential hose spigot, and the shaft includes a driver interface for connecting to a handheld drill or driver. In use, the hose spigot may be activated, passing water through the cylindrical body and out a window to flush a paintbrush. The brush protrudes from the window, and as the shaft is driven by a driver, the brush can rapidly and mechanically clean a paintbrush which has been placed in the window. Simultaneously, the rush of water rapidly flushes all paint, stainer, thinner, debris, or other applicants from the paintbrush.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of painting of existing art and more specifically relates to a paintbrush cleaning device.

### RELATED ART

In its most basic form, painting involves the use of an applicator, such as a paintbrush, to apply a paint mixture to a surface. These paintbrushes use fine bristles to evenly apply paint to the surface that they come in contact with. While this is an efficient method of forming an adequately even painted surface, it does cause difficulties in cleaning the paintbrush after use. Each fine bristle retains paint, and as the paint quickly dries, the bristles harden with paint and bind to one another. The paintbrush must be quickly cleaned after use or the paintbrush will be rendered permanently unusable. The process of cleaning paintbrushes is messy and labor intensive, and disrupts efficient workflow. A superior solution is desired.

U.S. Pat. No. 5,381,964 to John M. Reyna relates to a hose bib mounted paintbrush cleaner. This cleaner threads to a standard ¾″ garden hose thread hose bib, and contains a manifold with several small jets which convert the low water pressure leaving the ¾″ fitting to multiple high pressure streams suitable for cleaning a paintbrush. However, the device lacks a sufficient mechanical cleaning feature, as is usually necessary in quickly and effective cleaning a paintbrush of applicants. A superior solution is yet desired.

### SUMMARY OF THE INVENTION

In view of the foregoing disadvantages inherent in the known paintbrush cleaner art, the present disclosure provides a novel spigot mounted paintbrush cleaner. The general purpose of the present disclosure, which will be described subsequently in greater detail, is to provide a paintbrush cleaner which operates quickly and effectively.

The paintbrush cleaner features a circular brush which rotates on a shaft within a cylindrical housing. The cylindrical housing has a bored threaded interface for attaching to a residential hose spigot, and the shaft includes a driver interface for connecting to a handheld drill or driver. Typically, this driver interface will be a female one-quarter inch hexagonal drive, which is the most common size in the United States for driver bits for drills and impact drivers. Since the entire exterior profile of these bits are generally one-quarter inch, bits can be utilized regardless of head type (Phillips, flathead, reduced hexagonal, hexalobular, etc.) as the bit head will be smaller than the one-quarter inch external bit size and will not engage the shaft. With the use of handheld, battery-operated drills and drivers, a user may quickly apply significant power to the paintbrush cleaner without setup or inconvenience.

In use, the hose spigot may be activated, passing water through the cylindrical body and out an access window in order to flush a paintbrush. The brush protrudes from the window, and as the shaft is driven by a driver, the brush rapidly and mechanically cleans a paintbrush which has been placed in the window. Simultaneously, the rush of water rapidly flushes all paint, stainer, thinner, debris, or other applicants from the paintbrush.

The resulting paintbrush cleaner is convenient and affordable. It is simple and requires minimal maintenance. At a jobsite, it may be attached to a hose spigot, and left attached for the duration of the job. The continual passage of water ensures that not only the paintbrush, but also the cleaner itself is continually flushed. The use of a large rotary brush, in combination with electric power and water flushing, makes it a faster and easier cleaning process than any other method of cleaning paintbrushes. Because it is mounted outside to a hose spigot, further cleanup afterwards is unnecessary.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a spigot mounted paintbrush cleaner, constructed and operative according to the teachings of the present disclosure.

FIG. 1 is a perspective view of the spigot mounted paintbrush cleaner mounted to a spigot during an ‘in-use’ condition, according to an embodiment of the disclosure.

FIG. 2 is a perspective view of the spigot mounted paintbrush cleaner of FIG. 1 disassembled, according to an embodiment of the present disclosure.

FIG. 3 is a cutaway perspective view of the spigot mounted paintbrush cleaner of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a paintbrush cleaner and more particularly to a spigot mounted paintbrush cleaner as used to improve the ease and efficiency of cleaning paintbrushes.

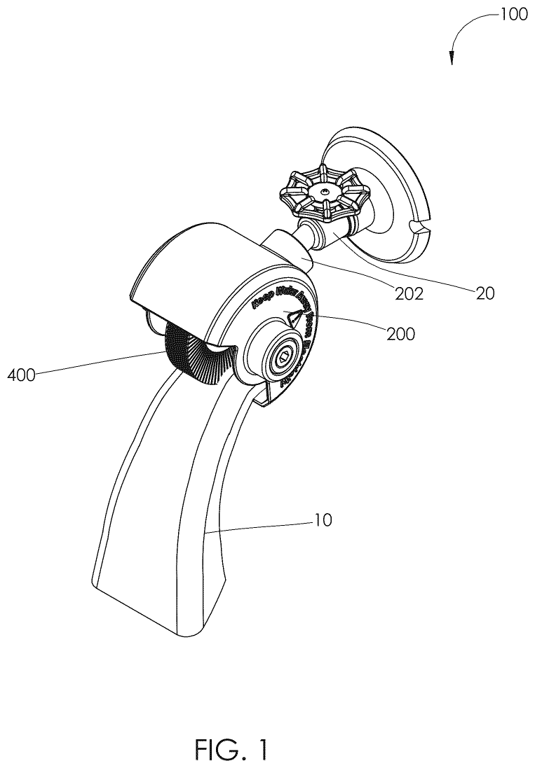

Referring now more specifically to the drawings by numerals of reference, there is shown in FIGS. 1-3, various views of a spigot mounted paintbrush cleaner assembly 100.

FIG. 1 shows a spigot mounted paintbrush cleaner assembly 100 during an ‘in-use’ condition, according to an embodiment of the present disclosure. Here, the paintbrush cleaner 100 may be beneficial for use by a user to clean paintbrushes with the assistance of an electrically-operated brush and the continual flushing of water. As illustrated, the paintbrush cleaner 100 may include cylindrical housing 200, mount 202 connecting cylindrical housing 200 to spigot 20 which provides water 10, and circular brush 400. As shown, spigot 20 continually passes water 10 through cylindrical housing 200 around brush 400, flushing any paintbrush that a user applies to brush 400.

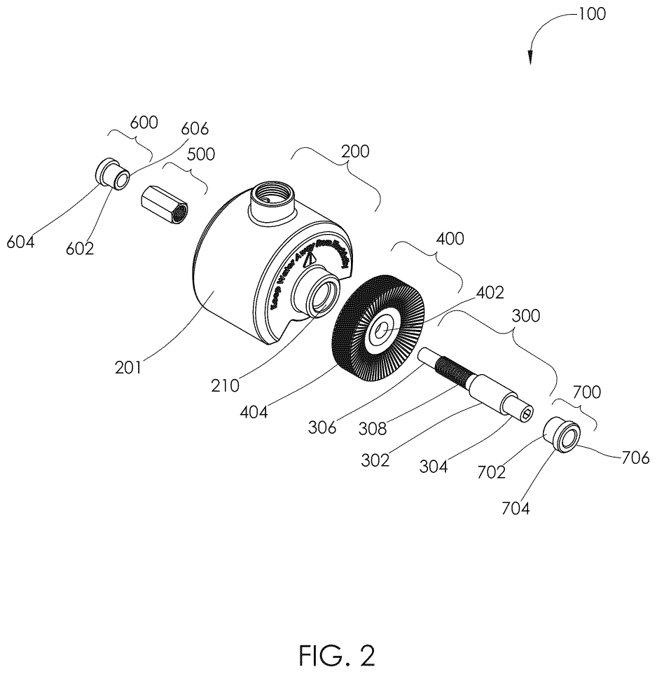

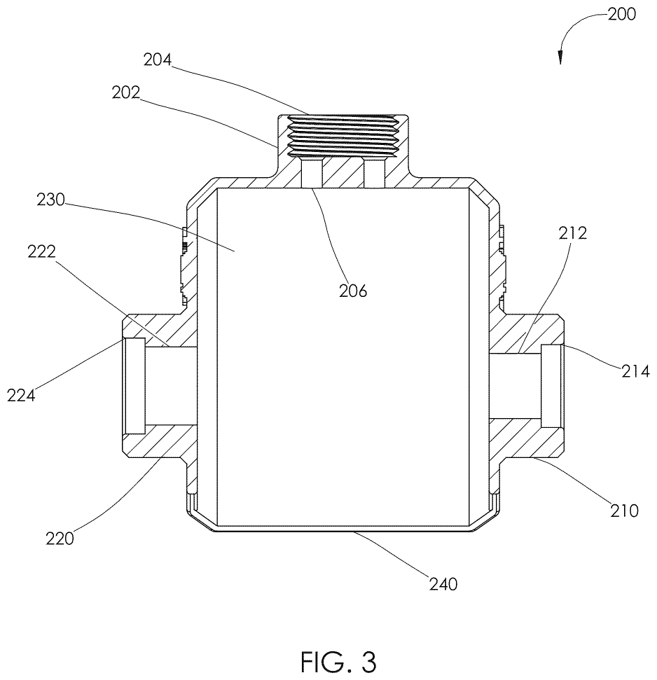

FIG. 2 is a perspective view of the spigot mounted paintbrush cleaner of FIG. 1 disassembled, according to an embodiment of the present disclosure. As shown, cylindrical housing 200 is hollow, being characterized by a cylindrical interior which encloses brush 400. During disassembly, brush 400 can be removed from cylindrical housing 200 through window 240 (FIG. 3) once shaft 300 is removed.

Shaft 300 passes through cylindrical housing 200 and center-bore 202 of brush 400, thereby retaining brush 400 within cylindrical housing 200, but permitting brush 400 to rotate freely on the axis formed by shaft 300. Shaft 300 includes first-end 304, second-end 306, and externally threaded interface 308 between first-end 304 and second-end 306. Shoulder 302 is also disposed between first-end 304 and second-end 306, being larger in diameter than the rest of shaft 300. First-end 304 may contain a driver interface, such as a ¼″ female hexagonal bore. In assembly, second-end 306 of shaft 300 may be passed through brush-bore 402 of brush 400. Brush 400 may be pressed all the way against shoulder 302, and nut 500 (which may be a coupler nut with a hexagonal exterior surface as shown) may be threaded upon externally threaded interface 308 to lock brush 400 against shoulder 302. As shown, nut 500 may be sufficiently wide to fill the space between brush 400 and the side of the interior of housing 200 to eliminate any axial lash or movement in shaft 300. The compression of brush 400 between nut 500 and shoulder 302 maintains a fixation between brush 400 and shaft 300, ensuring that all rotational energy imparted into shaft 300 also spins brush 400. This assembly must be done with brush 400 being within housing 200. Accordingly, a user is forced to insert second-end 306 through first-mount 210, then through brush-bore 402, through nut 500, and then finally unto second-mount 220. After this assembly procedure is completed, first-bushing 700 may be inserted into first-mount 210, and second-bushing 600 may be inserted into second-mount 220. The installation of these bushings ensures proper tolerancing between shaft 300 and the mounts, and also offers the opportunity to replace first-bushing 700 and second-bushing 600 as wear parts as necessary. In some embodiments, first-bushing 700 and second-bushing 600 may be toleranced to be press-fit into first-mount 210 and second-mount 220 respectively. In this way, the press-fit acts as an effective retention mechanism to ensure that shaft 300 does not migrate out of housing 200 even under energetic use. Alternative embodiments may implement alternative fastening mechanisms.

As shown, it is preferred that first-bushing 700 include a first-minor-diameter sleeve 702, a first-major-diameter flange 704 to prevent over-insertion, and a first-bushing-bore 706 properly tolerated to accept shaft 300. Likewise, second-bushing 600 may include a second-minor-diameter sleeve 602, a second-major-diameter flange 604 to prevent over-insertion, and a second-bushing-bore 606 properly tolerated to accept shaft 300. In one embodiment, it may be that shaft 300 is press-fit to each of first-bushing-bore 706 and second-bushing-bore 606; as the respective flanges prevent either bushing from migrating inwardly towards brush 400, this may act as an effective retention mechanism. First-bushing 700 and second-bushing 600, in this embodiment, spin with shaft 300, and are toleranced to spin freely within first-mount 210 and second-mount 220 without significant runout. However, in alternatively embodiments, first-bushing 700 and second-bushing 600 may be press-fit to first-mount 210 and second-mount 220 respectively.

FIG. 3 is a cutaway perspective view of the spigot mounted paintbrush cleaner of FIG. 1, according to an embodiment of the present disclosure.

Shaft 300 (FIG. 2) may pass through first-mount 210 and second-mount 220 at either end. Accordingly, shaft 300 (FIG. 2) is unsupported in the middle, rotating within interior volume 230, and itself supports brush 400 (FIG. 2). First-mount 210 includes first-bore 212 which is dimensioned to circumscribe shaft 300 (FIG. 2). First-bore 212 is also interrupted by first-relief 214, which is concentric to first-bore 212, and is sufficiently large to accept a first-bushing 700 (FIG. 2). First-relief 214 may be toleranced to accept first-major-diameter flange 704. First-bushing 700 (FIG. 2) may be toleranced to shaft 300 (FIG. 2) in order to permit free rotation of shaft 300 (FIG. 2) while preventing lash.

Likewise, second-mount 220 includes second-bore 222 which is dimensioned to circumscribe shaft 300 (FIG. 2). Second-bore 222 is also interrupted by second-relief 224, which is concentric to second-bore 222, and is sufficiently large to accept a second-bushing 600 (FIG. 2). Second-relief 224 may be toleranced to accept second-major-diameter flange 604. Second-bushing 600 (FIG. 2) may be toleranced to shaft 300 (FIG. 2) in order to permit free rotation of shaft 300 (FIG. 2) while preventing lash. Preferably, each of first-relief 214 and second-relief 224 are cut into an exterior side of their respective bores, as is desirable for convenient assembly and maintenance of paint cleaner 100.

As shown, window 240 is cut into cylindrical housing 200 and intersects the interior space, allowing brush 400 (FIG. 2) to protrude from cylindrical housing 200. Window 240 may be a variety of shapes, and may cut into housing 200 and into both first-end 304 and second-end 306 on either side. Window 240 may open over one-hundred and eighty degrees about cylindrical housing 200 in some embodiments. Additionally, the edges of window 240 may define arcuate edges, chamfers, guards, or a variety of features. In essence, window 240 must allow sufficient access for a paintbrush to contact brush 400, without compromising the structure of cylindrical housing 200 and particularly first-end 304 and second-end 306 which mechanically support shaft 300. Preferably, window 240 is distal to spigot-mount 202, enabling water to pass fully around and through brush 400 and exit through window 240. If water is forced to turn at a sharp angle to reach window 240, this would reduce velocity and effectiveness of the flushing water stream. Preferably, window 240 is as wide or nearly as wide as the interior space itself, and is cut back along the top and bottom to form at least thirty degrees of the cylindrical housing 200, in order to provide sufficient access for paintbrushes of varying sizes to contact brush 400.

Water is able to pass through from mount 202 into interior volume 230 via one or more channels 206. Mount 202 is characterized by internal threading 204, which in a preferred embodiment, is a female ¾″ garden hose thread. In the preferred embodiment, channel 206 is a simple bore concentric with internal threading 204. Mount 202 is preferably unitary with housing 200. While exact location of mount 202 is not critical, it is preferred that it be positioned roughly opposite window 240, and be centered between first-end 304 and second-end 306, such that when housing 200 is mounted to a hose bib, it is not imbalanced, and water flow may be disbursed equally throughout interior volume 230.

Upon reading this specification, it should be appreciated that, under appropriate circumstances, considering such issues as user preferences, design preference, structural requirements, marketing preferences, cost, available materials, technological advances, etc., other structural arrangements such as, for example, different housing shapes, different window arrangements, extended brushes, auxiliary features, etc., may be sufficient.

It should be noted that, under appropriate circumstances, considering such issues as design preference, user preferences, marketing preferences, cost, structural requirements, available materials, technological advances, etc., other methods for effectively cleaning paintbrushes are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A paintbrush cleaning device comprising:
a cylindrical-housing having
a circular front-side,
a circular back-side,
a cylindrical-sidewall spanning between the circular front-side and the circular back-side,
a cylindrical-interior concentric with the cylindrical-sidewall,
a spigot-mount intersecting the cylindrical-interior, the spigot-mount including an internally threaded interface and a bore, the bore being able to bring the cylindrical-interior into fluid communication with a spigot,
a window intersecting the cylindrical-interior, the window not intersecting the spigot-mount;
a shaft passing through the cylindrical-housing from the circular front-side to the circular back-side, and
a circular-brush rotatably mounted upon the shaft within the cylindrical-interior, the circular-brush having a brush-bore able to accept the shaft.

2. The paintbrush cleaning device of claim 1, wherein the internally threaded interface is a female three-quarter inch garden hose thread able to connected to a hose spigot.

3. The paintbrush cleaning device of claim 1, wherein the circular front-side includes a front-shaft-bore, and the circular back-side includes a back-shaft-bore.

4. The paintbrush cleaning device of claim 3, wherein each of the front-shaft-bore and the back-shaft-bore are relieved in order to accept a front-bushing and a rear-bushing respectively.

5. The paintbrush cleaning device of claim 1, wherein the shaft comprises
an externally threaded interface,
a first-end,
a second-end,
a driver-interface bored into the first-end, the driver-interface enabling a user to affix a driver to the driver-interface and rotate the shaft using the driver.

6. The paintbrush cleaning device of claim 5, wherein the driver-interface is a female hexagonal one-quarter inch drive.

7. The paintbrush cleaning device of claim 5, wherein the shaft further comprises a shoulder proximal to the externally threaded interface.

8. The paintbrush cleaning device of claim 7, wherein the circular-brush comprises a brush-bore, the brush-bore being sufficiently large in diameter to pass over the externally threaded interface of the shaft, the brush-bore being smaller in diameter than the shoulder, such that a nut may be applied to the externally threaded interface to lock the circular-brush against the shoulder.

9. The paintbrush cleaning device of claim 7, further comprising a nut able to threadably attach to the externally threaded interface of the shaft.

10. The paintbrush cleaning device of claim 4, wherein the front-shaft-bore comprises a front-relief facing away from the cylindrical-interior;
the rear-shaft-bore comprises a rear-relief facing away from the cylindrical-interior;
the front-bushing comprises a front-flange, the front-flange being smaller in diameter than the front-relief; and
the rear-bushing comprises a rear-flange, the rear-flange being smaller in diameter than the rear-relief;
such that when the front-bushing and the rear-bushing are each installed to the shaft, the front-flange abuts against the front-shaft-bore, and the rear-flange abuts against the rear-shaft bore, preventing axial movement of the shaft within the cylindrical housing.

11. The paintbrush cleaning device of claim 4, wherein each of the front-bushing and the rear-bushing are press-fit to the shaft, and thereby retain the shaft within the cylindrical housing.

12. The paintbrush cleaning device of claim 5, wherein the brush-bore is larger in diameter than the externally threaded interface.

13. The paintbrush cleaning device of claim 5, wherein the driver-interface is concentric to the shaft.

14. A paintbrush cleaning device comprising:
a cylindrical-housing having
a circular front-side,
a circular back-side,
a cylindrical-sidewall spanning between the circular front-side and the circular back-side,
a cylindrical-interior concentric with the cylindrical-sidewall,
a spigot-mount intersecting the cylindrical-interior, the spigot-mount including an internally threaded interface and a bore, the bore being able to bring the cylindrical-interior into fluid communication with a spigot,
a window intersecting the cylindrical-interior, the window not intersecting the spigot-mount;
a shaft passing through the cylindrical-housing from the circular front-side to the circular back-side, and
a circular-brush rotatably mounted upon the shaft within the cylindrical-interior, the circular-brush having a brush-bore able to accept the shaft;
wherein the internally threaded interface is a female three-quarter inch garden hose thread able to connected to a hose spigot;
wherein the circular front-side includes a front-shaft-bore, and the circular back-side includes a back-shaft-bore;
wherein the shaft comprises
an externally threaded interface,
a first-end,
a second-end,
a driver-interface bored into the first-end, the driver-interface enabling a user to affix a driver to the driver-interface and rotate the shaft using the driver;
wherein the shaft further comprises a shoulder proximal to the externally threaded interface; and
wherein the circular-brush comprises a brush-bore, the brush-bore being sufficiently large in diameter to pass over the externally threaded interface of the shaft, the brush-bore being smaller in diameter than the shoulder, such that a nut may be applied to the externally threaded interface to lock the circular-brush against the shoulder.

15. A paintbrush cleaning device comprising:
a cylindrical-housing having
a circular front-side,
a circular back-side,
a cylindrical-sidewall spanning between the circular front-side and the circular back-side,
a cylindrical-interior concentric with the cylindrical-sidewall,
a spigot-mount intersecting the cylindrical-interior, the spigot-mount including an internally threaded interface and a bore, the bore being able to bring the cylindrical-interior into fluid communication with a spigot,
a window intersecting the cylindrical-interior, the window not intersecting the spigot-mount;
a shaft passing through the cylindrical-housing from the circular front-side to the circular back-side, and
a circular-brush rotatably mounted upon the shaft within the cylindrical-interior, the circular-brush having a brush-bore able to accept the shaft;
wherein the internally threaded interface is a female three-quarter inch garden hose thread able to connected to a hose spigot;
wherein the circular front-side includes a front-shaft-bore, and the circular back-side includes a back-shaft-bore;
wherein the shaft comprises
an externally threaded interface,
a first-end,
a second-end,
a driver-interface bored into the first-end, the driver-interface enabling a user to affix a driver to the driver-interface and rotate the shaft using the driver;
wherein the shaft further comprises a shoulder proximal to the externally threaded interface;
wherein the circular-brush comprises a brush-bore, the brush-bore being sufficiently large in diameter to pass over the externally threaded interface of the shaft, the brush-bore being smaller in diameter than the shoulder, such that a nut may be applied to the externally threaded interface to lock the circular-brush against the shoulder;
further comprising a nut able to threadably attach to the externally threaded interface of the shaft;
wherein the front-shaft-bore comprises a front-relief facing away from the cylindrical-interior;
wherein the rear-shaft-bore comprises a rear-relief facing away from the cylindrical-interior;
wherein the front-bushing comprises a front-flange, the front-flange being smaller in diameter than the front-relief; and
wherein the rear-bushing comprises a rear-flange, the rear-flange being smaller in diameter than the rear-relief;
such that when the front-bushing and the rear-bushing are each installed to the shaft, the front-flange abuts against the front-shaft-bore, and the rear-flange abuts against the rear-shaft bore, preventing axial movement of the shaft within the cylindrical housing;
wherein each of the front-bushing and the rear-bushing are press-fit to the shaft, and thereby retain the shaft within the cylindrical housing;
wherein the brush-bore is larger in diameter than the externally threaded interface; and
wherein the driver-interface is concentric to the shaft.
